(19) United States
(12) Patent Application Publication
(10) Pub. No.: US 2012/0210952 A1
(43) Pub. Date: Aug. 23, 2012

(54) MOTOR VEHICLE WITH A COMBUSTION ENGINE, AND METHOD OF OPERATING A COMBUSTION ENGINE

(75) Inventors: Thomas Reuss, Neuenstadt (DE); Marc Fessler, Eberstadt (DE)

(73) Assignee: Audi AG, Ingolstadt (DE)

(21) Appl. No.: 13/213,222

(22) Filed: Aug. 19, 2011

(30) Foreign Application Priority Data
Aug. 21, 2010 (DE) 10 2010 035 085.0

(51) Int. Cl. F02B 33/00; F02B 29/04; F02B 63/04

(52) U.S. Cl. 123/2; 123/559.1; 123/542

(57) ABSTRACT

A motor vehicle includes a combustion engine and an intake tract for feeding air to the combustion engine. A compressor is arranged in the intake tract for compressing air, and a turbine is arranged in the intake tract downstream of the compressor and powered by air compressed in the compressor.

### CROSS-REFERENCES TO RELATED APPLICATIONS

This application claims the priority of German Patent Application, Serial No. 10 2010 035 085.0, filed Aug. 21, 2010, pursuant to 35 U.S.C. 119(a)-(d), the content of which is incorporated herein by reference in its entirety as if fully set forth herein.

### BACKGROUND OF THE INVENTION

The present invention relates to a motor vehicle with a combustion engine, and to a method of operating a combustion engine.

It would be desirable and advantageous to provide an improved motor vehicle with a combustion engine which can be operated in a highly efficient manner.

### SUMMARY OF THE INVENTION

According to one aspect of the present invention, a motor vehicle includes a combustion engine, an intake tract for feeding air to the combustion engine, a compressor arranged in the intake tract for compressing air, and a turbine arranged in the intake tract downstream of the compressor and powered by air compressed in the compressor.

The turbine downstream of the compressor, as viewed in flow direction of air through the intake tract, provides for a so-called cold-air turbine which during operation of the combustion engine is able to recover energy that is contained in air compressed by the compressor and to utilize this energy as drive for at least one further aggregate and/or to convert it into electric energy or to utilize it in any other appropriate manner. As a result, the combustion engine and thus the overall motor vehicle runs very efficiently, thereby reducing energy demand and thus fuel consumption to operate the motor vehicle. In addition, CO₂ emission is also low. This is rendered possible because the energy of the compressed air can be used, rather than requiring additional fuel, to operate the motor vehicle for example and/or to supply energy to at least a further consumer like an electric generator for example.

The compressor may for example be part of an exhaust turbocharger which also includes a turbine which can be powered by exhaust gas from the combustion engine and via which the compressor can be powered for compressing air for the combustion engine. In this way, energy contained in the exhaust gas can be used to power the compressor via the turbine. This permits recovery of further energy which otherwise would have been wasted and merely released to the environment as heat.

The provision of the compressor enables in particular an efficient use of energy contained in the exhaust gas in order to compress air to a pressure level which is higher than would actually be necessary for an optimal operation in terms of fuel consumption of the combustion engine. In other words, the exhaust gas provides sufficiently high energy to compress air to such a high pressure level via the turbine and the compressor. This enables recovery of especially much energy from exhaust gas. Air compressed to this very high pressure level, also labeled charging pressure, is relieved by the turbine downstream of the compressor to a lower pressure level and thus decreased to a level that is beneficial and desired for optimal operation in terms of fuel consumption of the combustion engine. Energy gained by this relaxation and pressure decrease as a result of the presence of the turbine can then be utilized to provide a very efficient operation at low fuel consumption of the combustion engine.

According to another advantageous feature of the present invention, the turbine may be operably connected to an electric generator. In this way, energy recovered by the turbine can be converted into electric energy. There is no need to burn added fuel by the combustion engine in order to convert this fuel into electric energy via, for example, a crankshaft of the combustion engine. Rather, fuel that is provided and burnt already for operating the combustion engine and operating the motor vehicle can now be used via the energy contained in the exhaust gas to produce electric energy.

According to another advantageous feature of the present invention, the electric generator may be used to drive an electric motor. This electric motor may be provided to operate one or more comfort-relating functions of the motor vehicle. For example, the electric motor may be used to power a coolant compressor of an air-conditioning unit or the like. When the motor vehicle is constructed as a hybrid vehicle which is powered by at least one electric motor in addition to the combustion engine, energy recovered and converted by the turbine can be used to operate this electric motor to drive the motor vehicle. As an alternative, or in addition, it is also possible to use the electric generator for charging an electric storage unit, such as a battery, of the motor vehicle. When the motor vehicle operates, for example, in an operating mode in which no recovered energy is needed, because no additional consumer has to be supplied with energy, the electric energy can advantageously be stored, in particular temporarily stored, and then retrieved and consumed, when needed for a respective operating mode of the motor vehicle. In this operating mode, it is necessary for example to supply an especially great number of electric consumers with electric energy which are then to be advantageously supplied with the recovered and temporarily stored energy. This further promotes decrease in fuel consumption of the combustion engine.

It is, of course, also conceivable to use the turbine for converting energy contained in air into mechanical energy or into any other form of energy and to exploit it and/or optionally to store it in a respective energy storage unit.

According to another advantageous feature of the present invention, a cooling device can be disposed in the intake tract for cooling air, with the turbine being arranged downstream of the cooling device. The cooling device may be constructed as charge-air cooler. As air is compressed by the compressor, air is heated. The provision of the cooling device allows a recooling of compressed and thereby heated air so that air has a particularly high supercharging rate (compression rate). In this way, especially much energy of compressed and re-cooled air can be recovered by the turbine and exploited to supply at least one consumer and/or to convert energy into a different form of energy and/or to store it. The motor vehicle operates in an especially efficient manner and at low emission, thereby keeping also the CO₂ emission low.

According to another advantageous feature of the present invention, the turbine can also be arranged upstream of the cooling device for cooling air. This arrangement of the turbine in relation to the cooling device and the compressor is beneficial because it allows an especially efficient operation of the turbine by compressed air. The energy contained in air can be utilized and recovered in a superior way in order to supply at least one consumer with energy and/or to convert the energy into another form of energy, especially electric energy. This further promotes to lower fuel consumption of the motor vehicle.

According to another advantageous feature of the present invention, a valve device can be disposed in the intake tract for adjusting an amount of air powering the turbine. In this way, the amount of air for powering the turbine can be adjusted to the need at hand and suited to a present operating point, especially of the combustion engine, so that an amount of energy recovered by the turbine can be adjusted to the need at hand.

With the valve device, it is possible for example to fluidly clear or block a fluid flow through a bypass line at least in some areas thereof. For example, in one position of the valve device, all compressed air can be used to power the turbine arranged in the intake tract. In another position of the valve device, it is possible to use a first subflow of compressed air for powering the turbine and to use a second subflow of compressed air to circumvent the turbine via the bypass line, without being expanded by the turbine, and to flow to the combustion engine and into a respective combustion chamber of the combustion engine. The second subflow thus is not utilized to power the turbine. It is also possible to adjust the valve device in such a way that no compressed air is conducted to the turbine, so that all of the compressed air circumvents the turbine via the bypass line and fed to the combustion engine, without powering the turbine. This mode of operation may be efficient in certain operating points of the combustion engine.

The valve device may be constructed as a switchable control valve or switchover valve or the like by which the air mass flow passing through the turbine can be adjusted

According to another advantageous feature of the present invention, the turbine can include an adjustment device for adjusting the air mass flow through the turbine. The adjustment device may have a variable turbine geometry or an adjustable slider. In this way, the output of the turbine can be varied over a broad spectrum and best suited to a multiplicity of different operating points of the combustion engine with varying air mass flows through the intake tract. This again promotes efficiency of operation of the turbine in this spectrum which in turn results in a very efficient operation of the combustion engine and thus of the overall motor vehicle.

According to another advantageous feature of the present invention, a control device can be provided for controlling or regulating the turbine and for controlling or regulating the combustion engine in terms of injection and combustion operations. In other words, an engine controller already provided for controlling or regulating the combustion engine can also be used to control and regulate the turbine in an efficient manner. As a result, the number of parts, costs, and weight of the motor vehicle can be kept small. In particular, the low weight positively affects fuel consumption and CO₂ emission. Furthermore, the low parts number resolves or avoids any package problems, especially in a space-critical zone, such as engine compartment in which the combustion engine is arranged in the motor vehicle.

Still it is, of course, also conceivable to provide an additional control device for controlling or regulating the turbine, which may positively affect the cost factor in the event repairs work should become necessary for example.

According to another aspect of the present invention, a method of operating a combustion engine of a motor vehicle includes the steps of feeding air to the combustion engine via an intake tract, compressing air by a compressor arranged in the intake tract, and powering a turbine, arranged in the intake tract downstream of the compressor, by air compressed by the compressor.

A method according to the present invention results in a particularly efficient operation of the combustion engine at low fuel consumption and low CO₂ emission because energy contained in air that has been compressed by the compressor can be recovered and used. This energy can then be stored and/or utilized for supply to at least one consumer.

According to another advantageous feature of the present invention, the air mass flow through the turbine can be adjusted and controlled or regulated in dependence of at least an ambient temperature and/or pressure and/or travel mode or operating state of the motor vehicle by at least one adjustment device. In this way, the air mass flow can be best suited to an existing operating point of the combustion engine to the need at hand and to run the turbine especially efficient.

As described above, it is possible to use a turbine of an exhaust turbocharger and arranged in an intake tract for the combustion engine of the motor vehicle for converting energy contained in the exhaust gas of the combustion engine into mechanical energy and thus to power the turbine and via the turbine the compressor. The exhaust gas contains much energy which can be utilized for the compressor to compress air to a respective pressure level which is higher than a pressure level which would be necessary for an optimal operation in terms of fuel consumption of the combustion engine. Thus, exhaust gas can be exploited especially efficient and a large amount of energy can be recovered which otherwise would be wasted and merely released as heat into the environment. This also leads to a particularly high pressure differential between the actually required and desired pressure level and by contrast the elevated pressure level in order to recover much energy contained in the compressed air as a result of an expansion of the compressed air to the lower and desired pressure level. This high amount of recovered energy allows supply of energy to at least one electric consumer, drive unit for driving the motor vehicle and/or charge of an energy storage unit, especially battery. There is no need for consuming additional fuel for supply or charging so that fuel consumption can be kept low despite the possible use of additional consumers, in particular electric consumers.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a basic illustration of a combustion engine according to the present invention, provided with a compressor and a turbine downstream of the compressor and powered by air compressed by the compressor for operating an electric generator;

FIG. 2 is a basic illustration of a combustion engine similar to FIG. 1, with the electric generator being used to power an electric motor and to charge an energy storage unit; and

FIG. 3 is a graphical illustration of two curves to illustrate the respective compressor output of the exhaust turbocharger according to FIGS. 1 and 2 as a function of the rpm of the combustion engine.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

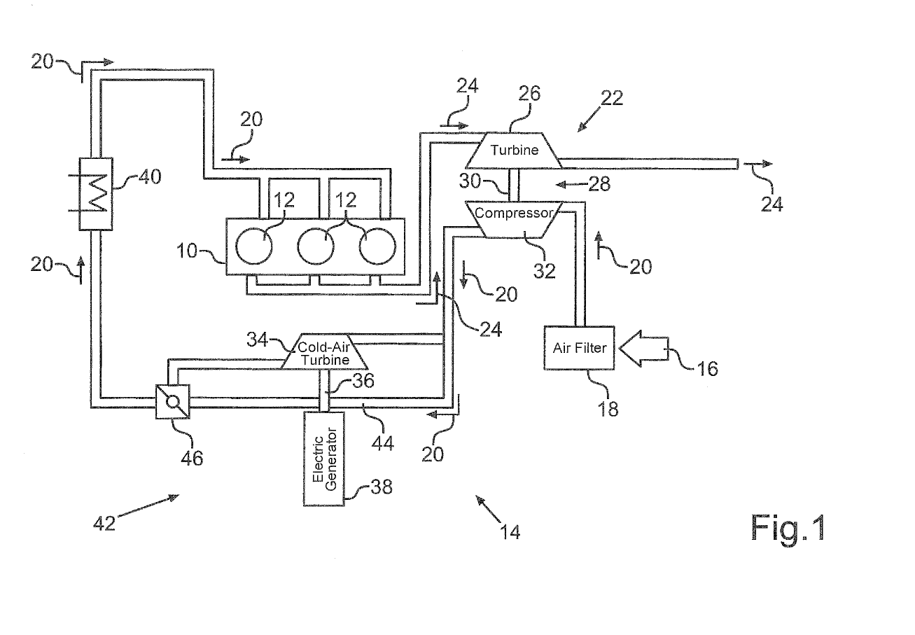

Turning now to the drawing, and in particular to FIG. 1, there is shown a basic illustration of a combustion engine 10 for a motor vehicle. The combustion engine 10 has three cylinders 12 and is supplied with air from an intake tract, generally designated by reference numeral 14. Air is drawn in by the combustion engine 10 according to arrow 16 and initially cleaned by an air filter 18 which is arranged in the intake tract 14. Air flows through the intake tract 14 according to arrows 20 and flows into the cylinders 12 in which air is exposed to fuel by direct fuel injection. An air-fuel mixture forms and is ignited in the cylinders 12 by external ignition or self-ignition and burnt. It is, of course, also possible to execute a so-called manifold injection in the combustion engine 10. In such a manifold injection, fuel is not directly injected into the cylinders 12. Fuel is introduced into an induction pipe or like induction module arranged in the intake tract 14 in flow direction of air upstream of the cylinders 12, so that an air-fuel mixture is formed already in the induction pipe whereupon the at least partly pre-mixed air-fuel mixture then flows into the cylinders 12 and is burnt there.

Combustion results in the combustion engine 10 in formation of exhaust gas which is carried away via an exhaust tract 22 for the combustion engine 10. Exhaust gas flows through the exhaust tract 22 according to arrows 24 and is released into the environment after undergoing cleaning in an exhaust emission control device, not shown in FIG. 1.

Arranged in the exhaust tract 22 is a turbine 26 of an exhaust turbocharger 28 for the combustion engine 10. Exhaust gas flows through and thereby powers the turbine 26. The turbine 26 is connected by a shaft 30 with a compressor 32 which forms part of the exhaust turbocharger 28 and is arranged in the intake tract 14.

The compressor 32 can thus be powered by the turbine 26 via the shaft 30 and compresses air to be supplied to the combustion engine 10 so that the desired torque and output of the combustion engine 10 can be realized.

In order to be able to operate the turbine 26 and thus the exhaust turbocharger 28 efficiently and optimally and to best suit them to different operating points of the combustion engine 10, the turbine 26 has variable turbine geometry (VTG). The turbine 26 may, however, also be configured as fixed geometry turbine which does not have any adjustable, variable turbine geometry.

As can be seen from FIG. 1, a cold-air turbine 34 is arranged in the intake tract 14 in flow direction of air according to arrows 20 downstream of the compressor 32 and is powered by air that has been compressed by the compressor 32. The cold-air turbine 34 can thus be used to recover energy contained in the compressed air.

The cold-air turbine 34 is coupled via a shaft 36 with an electric generator 38 which is operated by the cold-air turbine 34 and provided to convert energy contained in the compressed air into electric energy.

To realize an especially efficient operation of the combustion engine 10 at low fuel consumption, a particularly great amount of energy contained in the exhaust gas of the combustion engine 10 is exploited to power the turbine 26 and thus the compressor 32 and to thus compress air to a pressure level which is higher than a pressure level required to be able to run the combustion engine 10 in optimum manner especially in terms of fuel consumption. Air compressed by the compressor 32 to this elevated pressure level is relaxed by the turbine 34 to the lower pressure level that is optimal for fuel consumption, wherein the resultant energy recovered by this expansion is utilized to power the cold-air turbine 34 and thus the generator 38. As a result, the combustion engine 10 can be supplied with a respective pressure level of air, also designated charging pressure, to implement an efficient operation of the combustion engine 10 at low fuel consumption.

On the other hand, much energy contained in the exhaust gas can be utilized and converted via the turbine 26, compressor 32, cold-air turbine 34 and the electric generator 38 into electric energy which otherwise would have been released unused in the form of heat to the environment. This further promotes low fuel consumption of the combustion engine 10. The electric energy and the energy contained in the exhaust gas can be used to supply an electric consumer for example. There is no provision or no need to burn additional fuel for supply of this consumer with energy by means of the combustion engine 10 and to convert it into electric energy.

To realize an especially high compression rate of air, a charge-air cooler 40 is arranged in the intake tract 14 downstream of the compressor 32 and downstream of the cold-air turbine 34 to cool the compressed and thereby heated air.

Also arranged in the intake tract 14 are a bypass line 44 and a control valve 46. The bypass line 42 is provided to allow adjustment of the powering air mass flow passing through the cold-air turbine 34. Thus, it is possible that the total amount of air compressed by the compressor 32 can be used to power the cold-air turbine 34. It is also possible that the total amount of air compressed by the compressor 32 circumvents the cold-air turbine 34 via the bypass line 44 so that the cold-air turbine 34 is not powered by compressed air. It is further possible, to power the cold-air turbine 34 with a subflow of air compressed by the compressor 32 and use another subflow of air compressed by the compressor 32 to circumvent the cold-air turbine 34 via the bypass line 44 without powering the cold-air turbine 34.

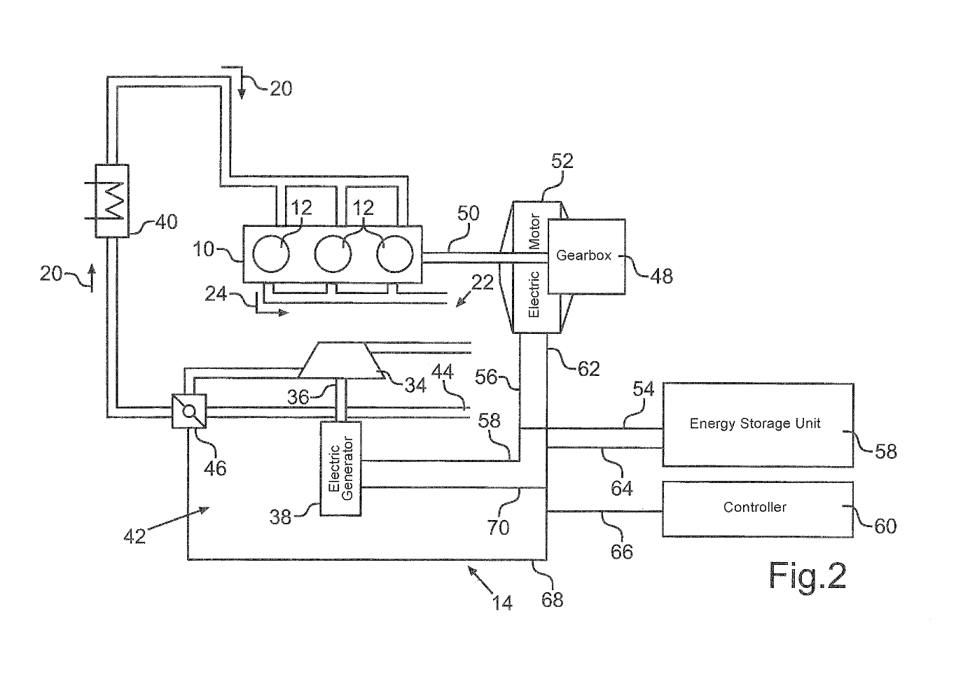

FIG. 2 shows the combustion engine 10 with the cold-air turbine 34 according to FIG. 1. Parts corresponding with those in FIG. 1 are denoted by identical reference numerals and not explained again. The description below will center on the differences between the embodiments. For sake of simplicity, part of the exhaust tract 22 with the turbine 26 and part of the intake tract 14 with the compressor 32 of the exhaust turbocharger 28 are not shown. In this embodiment, a gearbox 48 of the motor vehicle is coupled with a crankshaft 50 of the combustion engine 10 and powered by the crankshaft 50.

The motor vehicle is a passenger car constructed as hybrid vehicle and includes an electric motor 52 which is also connected with the crankshaft 50 and provided to propel the motor vehicle. The electric motor 52 may also serve as starter generator for starting the combustion engine 10 so as to eliminate the need for an additional starter device for starting the combustion engine 10. This keeps the parts number and weight low, thereby positively affecting efficient operation of the combustion engine 10 at low fuel consumption.

To operate the electric motor 52 in order to start the combustion engine 10 for example or to power the motor vehicle, the electric motor 52 requires electric energy. This electric energy may be received for example via respective lines 54, 56 from an energy storage unit 58 which can be configured as a battery for example. The energy storage unit 58 is in turn coupled via the line 54 and a further line 58 with the electric generator 38. As a result, energy of the compressed air that has been converted into electric energy can be used to supply the battery 58 and to charge it. Moreover, the thus gained electric energy can be used to directly supply the electric motor 52 via the lines 58, 56 and to power it.

The motor vehicle further includes a controller 60 which is connected via lines 62, 64, 66, 68, 70 with the electric motor 52, energy storage unit 58, control valve 46 and electric generator 38 for signal transmission and respective control or regulation.

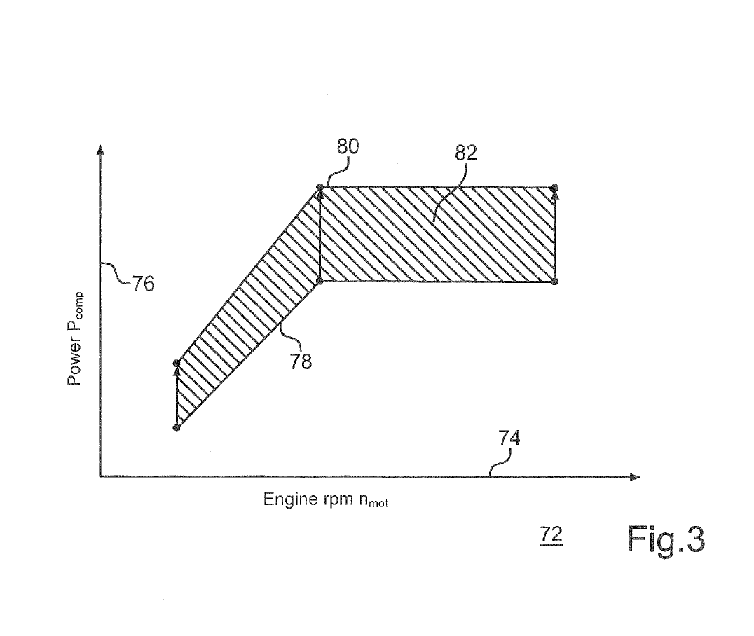

FIG. 3 shows a graph 72, with the engine rpm nₘₒₜ of the combustion engine 10 being plotted on the abscissa 74. Plotted on the ordinate 76 is the power P_{comp} of the compressor 72 of the exhaust turbocharger 28 according to FIGS. 1 and 2.

The graph 72 illustrates a first profile 78 of the power P_{comp} of the compressor 32. When operating the compressor 32 with this power P_{comp} in correspondence with the profile 78, air is compressed by the compressor 72 to such a pressure level as to provide a charging pressure for the combustion engine 10 in order to operate the combustion engine 10 in an optimal and highly efficient manner especially with respect to fuel consumption. In other words, a charging pressure is available to provide a respective air mass that is very beneficial for combustions in the cylinders 12 and leads to a low fuel consumption which realizing the desired power and torque.

As described above, sufficient energy exists in the exhaust gas of the combustion engine 10 in order to power the compressor 32 at a disproportionally higher compressor output P_{comp}. Accordingly, graph 72 illustrates a second profile 80 of such an elevated compressor output P_{comp} which starting from the profile 78 has a compressor output P_{comp} which for example is greater by 10% so that the respective charging pressure is increased by 10%. Air is thus compressed to a pressure level which is higher by 10% compared to the pressure level that is optimal especially with respect to fuel consumption.

The differential of this pressure level, represented by the difference between the profiles 78, 80 plotted in the graph 72 results in an energy potential 82 derived from the product of the elevated charging pressure and an elevated air throughput for the cold-air turbine 34. The cold-air turbine 34 is then able to relax the compressed air from the elevated charging pressure according to profile 80 to the charging pressure according to profile 78 that is optimal in terms of fuel consumption. Thus, energy (energy potential 82) resultant from expansion can be utilized to power the generator 38 which converts this energy into electric energy and charges accordingly the energy storage unit 58 and/or powers the electric motor 52. In this way, energy is recovered from air compressed by the compressor 32, with a power R_{recovery} of this recovery being dependent from the difference between the compressor outputs P_{comp} according to the profiles 78, 80, from the efficiency of the cold-air turbine 34, from the efficiency of the generator 38 as well as from an efficiency which takes into account a possible influence of the combustion engine by this recovery. In other words, the energy potential 82 may not be fully utilized because of losses as a result of not ideal efficiencies and converted into electric energy by the generator 38.

Still, a major proportion of the energy potential 82 as a result of the charging pressure increase and increase of the compressor outputs P_{comp} according to the profiles 78, 80 can be utilized to power the generator 38 and thus to provide electric energy. This results in a very efficient operation of combustion engine 10 at low fuel consumption.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A motor vehicle, comprising:
a combustion engine;
an intake tract for feeding air to the combustion engine;
a compressor arranged in the intake tract for compressing air; and
a turbine arranged in the intake tract downstream of the compressor and powered by air compressed in the compressor.

2. The motor vehicle of claim 1, further comprising an electric generator operably connected to the turbine.

3. The motor vehicle of claim 2, wherein the electric generator is configured to power an electric motor and/or to charge an electric storage unit.

4. The motor vehicle of claim 3, wherein the electric storage unit is a battery.

5. The motor vehicle of claim 1, further comprising a cooling device disposed in the intake tract for cooling air, said turbine being arranged downstream of the cooling device.

6. The motor vehicle of claim 1, further comprising a cooling device disposed in the intake tract for cooling air, said turbine being arranged upstream of the cooling device.

7. The motor vehicle of claim 1, further comprising a valve device disposed in the intake tract for adjusting an amount of air powering the turbine.

8. The motor vehicle of claim 1, wherein the turbine includes an adjustment device for adjusting an air mass flow through the turbine.

9. The motor vehicle of claim 8, wherein the adjustment device has a variable turbine geometry.

10. The motor vehicle of claim 7, wherein the adjustment device has an adjustable slider.

11. The motor vehicle of claim 1, further comprising a control device for controlling or regulating the turbine and for controlling or regulating the combustion engine.

12. A method of operating a combustion engine of a motor vehicle, comprising the steps of:
feeding air to the combustion engine via an intake tract;
compressing air by a compressor arranged in the intake tract; and
operating a turbine, arranged in the intake tract downstream of the compressor, by air compressed by the compressor.

13. The method of claim 12, wherein an air mass flow through the turbine is adjustable in dependence of at least one parameter selected from the group consisting of ambient temperature, pressure, travel mode or operating state of the motor vehicle.
